(19) United States
(12) Patent Application Publication
(10) Pub. No.: US 2005/0230485 A1
(43) Pub. Date: Oct. 20, 2005

(54) Specially shaped smart card for compact applications

(76) Inventors: Bruce Eric Ross, San Clemente, CA (US); Roger Bushong JR., Costa Mesa, CA (US)

Correspondence Address: Dennis H. Lambert & Associates, 7000 View Park Drive, Burke, VA, 22015, US

(21) Appl. No.: 11/111,176

(22) Filed: Apr. 20, 2005

Related U.S. Application Data
(60) Provisional application No. 60/563,630, filed on Apr. 20, 2004.

(51) Int. Cl. G06K 19/06; G06K 7/00

(52) U.S. Cl. 235/492; 235/486

(57) ABSTRACT

A small form factor smart card has a card body with a first end having structure for attachment to a keychain or other tether, and a second end carrying an embedded chip. Locking structure is on the card body for cooperation with locking structure associated with a card reader/writer for holding the card in place in the reader/writer during an operation. In a preferred embodiment, the locking structure associated with the card reader/writer is carried by an adaptor that is inserted into a slot of the reader/writer, and the card is inserted into a slot of the adaptor.

This application claims the benefit of U.S. Provisional Patent Application Ser. No. 60/563,630, filed Apr. 20, 2004.

### FIELD OF THE INVENTION

This invention relates generally to machine-readable cards that contain data for various transactions, including but not limited to security authorization, sales transactions, and the like. More particularly, the invention relates to a small form factor contact smart card that is compact in size and that can be read by existing smart card readers when used with an associated adaptor, or when used with readers that are configured for accepting and reading the card. The invention also relates to an adaptor that permits use of the small form factor contact smart card with readers having card-receiving openings sized for accepting conventionally sized contact smart cards, i.e., the CR80 card.

### BACKGROUND OF THE INVENTION

Credit cards and other authorization cards are well known for conducting sales transactions, authorizing access to secure locations, and the like. These conventional cards normally are made of plastic and are in the CR80 format, i.e., have dimensions of approximately 2.125×3.375 inches. On most such existing cards, data is stored in a bar code applied to the card, or in a magnetic stripe applied to one side of the card near one edge. They generally are used by sliding or “swiping” the card through a card reader that detects the information stored on the card and transmits that information, or relevant parts thereof, to a local or remote terminal for verifying the information and authorizing the requested transaction.

Compact, small form-factor “information carriers” have been developed and are being used for everything from military dog tags to grocery store member discount cards. Some bar code and magnetic stripe cards are no larger than a key and can be carried on a key chain. These types of cards are machine-readable for most applications, but for a few applications the cards have further evolved from the magnetic stripe to a wide variety of technologies, including RFID cards and tokens and associated readers that read data simply by passing the card or token close to the reader, thereby eliminating the need for card insertion.

The advent of miniaturized computing systems has led to the development of contact smart cards that have an on-board chip, thus expanding the scope and nature of data that can be stored on the cards, and concomitantly expanding the scope and nature of transactions that can be performed with the cards.

Smart cards improve upon the magnetic strip technology currently in use on many plastic cards. The smart card acts as a miniature personal computer with its own processor/memory architecture, using an operating system on which applications are executed, or acting as a secure storage device that limits access to its contents with its on-board logic.

Most conventional contact smart cards having embedded chips conforming to ISO 7816-x (where “x” indicates the series, i.e., “1”, “2”, etc.) are the size and shape of standard credit cards (CR 80 form factor), roughly 2.125×3.375 inches.

Small form factor smart cards are much smaller than CR80 cards. One example is the standardized SIM/SAM format found in GSM cell phones. This small form factor card has dimensions of about 0.98×0.6 inches and is placed in the phone and left there during normal use. It normally is not removed by the consumer, and is neither designed nor intended for frequent insertion into and removal from a slot in a reader in order to carry out occasional or frequent transactions.

Typical smart card readers/writers and terminals have an input slot or “throat” that guides a CR80 format card to a connector to make an electrical connection to the integrated circuit (chip) on the card. It is critical that the card be accurately guided into the correct connector position, or the electrical connection will not be made. Conventional readers thus are designed for use with conventionally sized cards. Small form factor contact smart cards generally cannot be read on conventional smart card readers because of their substantially smaller size, and the inability of the larger sized throat in conventional readers to accurately guide and position the small form factor contact smart card.

Some specialized readers have been developed for use with the GSM SIM/SAM small form factor smart cards, but these are not designed for repeated insertion and removal by the user. These readers are designed for an installed card.

Accordingly, there is need for a small form factor contact smart card that has means for securing it in position in the reader, and for an adaptor that enables small form factor smart cards to be used with conventional (CR80 form factor) smart card reader/writers.

### SUMMARY OF THE INVENTION

The present invention is a compact small form factor contact smart card conforming to industry standard ISO 7816 and its extensions, i.e., ISO-7816-x, where “x” designates an extension, e.g., “1”, “2”, etc., and that is designed for frequent insertion into and removal from readers by the user of the card. In particular, the card of the invention has means to securely hold it in position in a card reader/writer. The invention also comprises a card-guide/adaptor that enables the card to be connected to any smart card reader.

The small size and ease of use of the card makes it particularly useful for many applications. For example, the card could be used with specially adapted parking meters, or parking garage access entry or exit points, and the like, to pay a designated amount, and/or for identification, etc. In this regard, the card can be attached to a keychain for portability and ease of use.

With keys or other object attached to the smart card, there is a greater tendency for the card to pull away from a reader or terminal. When a card is removed during the reading or writing cycle there is a high probability of loss or corruption of data. To hold the card of the invention inserted in a reader/writer and prevent premature removal of the card contacts from the reader or terminal contacts prior to the end of a session, the card has a “locking” feature.

The locking feature of the invention is any mechanical device or structure that can be employed on the card and/or reader/terminal to lock the card in place and prevent its inadvertent removal from the reader contacts. Small indents on either side of the card are one example of a suitable mechanical locking means. This mechanical lock ensures that the card remains in the reader and that the reading process is complete and accurate.

The card-guide/adaptor of the invention is designed to be received in a standard size card reader, and has a guide slot for receiving and holding the small form factor contact smart card of the invention, thereby enabling the small form factor contact smart card of the invention to be used with existing readers and terminals. The card-guide/adaptor ensures that the card is accurately guided into the connector correctly. Cooperating detent means on the adaptor and card prevent inadvertent dislodgement of the card during a reading process.

This card acceptance method, i.e., use of a small form factor contact smart card with an adaptor that permits use of the card with conventional reader/writers, permits selective use of either the CR80 format or the small form factor card, depending on the type of card the user has decided to use. This permits one CR80 size smart card reader to be used for several different card formats, thus eliminating the need for a user to have to purchase several different smart card readers-writers and/or terminals in order to receive the different form factors of contact smart cards.

### BRIEF DESCRIPTION OF THE DRAWINGS

The foregoing, as well as other objects and advantages of the invention, will become apparent from the following detailed description when taken in conjunction with the accompanying drawings, wherein like reference characters designate like parts throughout the several views, and wherein:

FIG. 1 is a top plan view, as manufactured, of a prior art GSM type SIM/SAM card prior to removal of the card via the breakaway tabs from the body of material with which it is manufactured.

FIG. 2 is a top plan view of the prior art GSM type SIM/SAM card after removal from the body of material, shown slightly enlarged, and showing the card as it is used.

FIG. 3 is a top plan view of a typical prior art CR80 format smart card.

FIG. 4 is a top plan view of a typical prior art mag-stripe card.

FIG. 5 is a top plan view of the small form factor smart card of the invention, adapted for attachment to a keychain or the like.

FIG. 6 is a top plan view of the small form factor card of the invention, as manufactured, and prior to removal from the body of material with which it is manufactured.

FIG. 7 is a top plan view of the card-guide/adaptor of the invention.

### DETAILED DESCRIPTION OF THE PREFERRED EMBODIMENTS

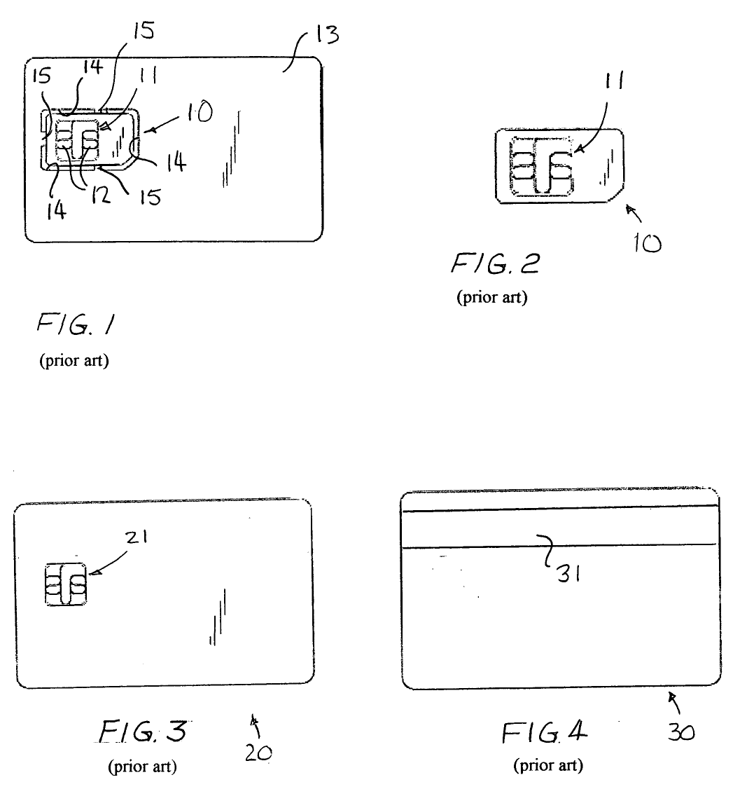

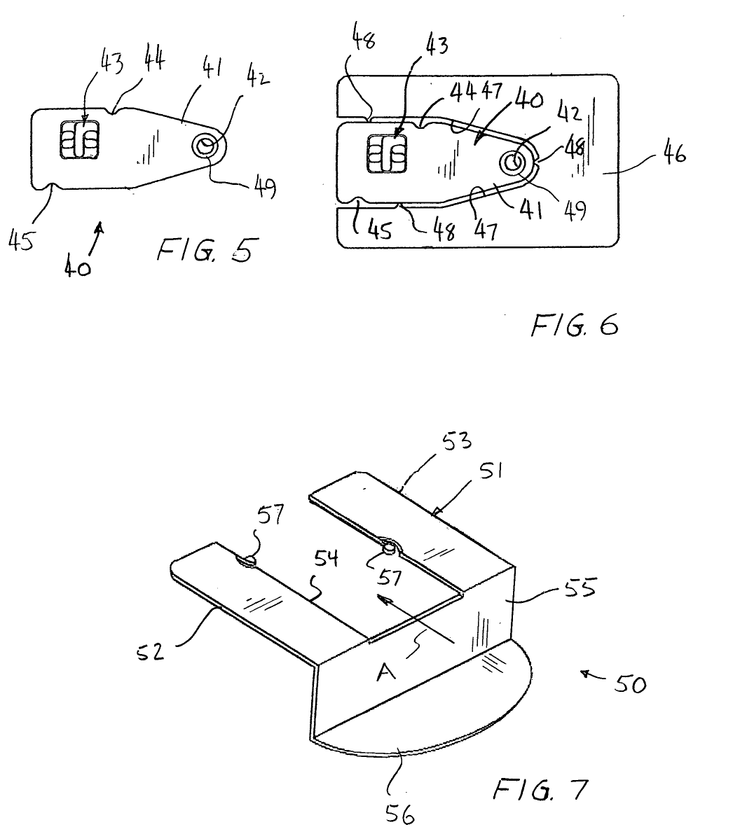

A prior art GSM type SIM/SAM card as used, for example, in cell phones, is indicated generally at 10 in FIG. 2. The card is approximately 0.98×0.59 inches and is adapted to be mounted in a cell phone for storing data relating to that customer's account, telephone numbers, etc. The card carries a chip 11 conforming to ISO 7816-x industry standards, and has contacts 12 for establishing communication with contacts in the phone (not shown). It is neither intended nor designed for frequent insertion into and removal from a card reader by the customer for carrying out transactions.

For ease of manufacture, the card 10 is molded or stamped integrally within a substantially credit card sized body of plastic 13. Areas of separation 14 are formed in the body of plastic, and the card 10 is joined to the body by breakaway tabs 15 so that the card can be separated from the body of plastic and placed in a cell phone or used in another application.

A typical prior art CR80 format contact smart card is indicated generally at 20 in FIG. 3. The CR80 card shown has an onboard chip 21 conforming to ISO 7816-x industry standards, with contacts for establishing communication with contacts in a CR80 card reader/writer (not shown).

A prior art card of the type having a magnetic stripe for storing data is indicated generally at 30 in FIG. 4. This card, in widespread use in the credit card industry, carries a magnetic stripe 31 on which data is stored. It is used by inserting it into or swiping it through a slot in a card reader (not shown).

The card of the invention is shown at 40 in FIG. 5. This card can be slightly larger than the GSM type SIM/SAM card of FIG. 2, i.e., in a preferred embodiment the card body has dimensions of approximately 1 inch by 2.37 inches, with an elongated end 41 having an opening 42 formed through it for attachment to a keychain if desired. Near the end opposite the opening 42, the card carries an embedded chip 43 conforming to ISO 7816-xx industry standards, with contacts for establishing communication with contacts in a conventional contact smart card reader/writer (not shown).

Suitable locking means are formed on the card to secure it against accidental dislodgement from a reader, and in the preferred embodiment shown this locking means comprises small notches or detents 44 and 45 in the side edges of the card. The locking means can cooperate with complemental locking means (not shown) in a specially adapted card reader (not shown) having dimensions and/or guide means for receiving the card 40 so that the contacts on the card are properly and accurately aligned with the contacts in the reader. Alternatively, the locking means can cooperate with complemental locking means in a specially constructed adaptor (described below) designed to enable the card to be used with conventional CR80 format contact smart card reader/writers.

The card 40 can be manufactured similarly to the way in which the GSM type SIM/SAM card of FIGS. 1 and 2 is made, that is, card 40 can be molded integrally with a body of plastic 46, with areas of separation 47 formed in the body of plastic around the periphery of the card, and breakaway tabs 48 joining the card to the body so that the card can be separated from the body of plastic.

Further, an eyelet 49 can be placed around the opening 42 in the card of the invention to reinforce the structure for use with a keychain or other tether.

As shown in FIG. 7, an adaptor 50 is provided to enable the card 40 to be used with conventional CR80 format contact smart card reader/writers. The adaptor comprises a bifurcated main body portion 51, with a pair of forwardly extending side arms 52 and 53 separated by an elongate slot 54 opening through both ends of the main body portion. A flange 55 depends from the proximal end of the main body portion, and terminates in a horizontally extending pull-tab 56 at its lower edge. In the preferred embodiment, locking means 57 are provided on the inner facing side edges of the arms 52 and 53 for cooperation with locking means on the card 40 to secure the card in position and prevent its inadvertent disengagement from the reader, or misalignment with the contacts in the reader. The locking means can comprise any suitable means for holding the card in place, but in the preferred embodiment comprise spring arms that yield to enable the forward end of the card to pass, then spring into place in the detents 44 and 45 in the side edges of the card to hold it in place until the user desires to remove the card.

In use, the adaptor 50 is inserted into the card-receiving slot or throat of a typical CR80 format contact smart card reader, and the card 40 is then inserted into the slot 54 of the adaptor, as indicated by the arrow A, where it is held by engagement of the locking spring arms 57 in the detents 44 and 45 of the card.

The card of the invention conforms to ISO 7816-x in any small form factor, and with the adaptor can be used with any smart card reader. It can be attached to a keychain or other tether for portability and ease of use, and in the preferred embodiment has locking means to secure it in place in the reader/writer during a read/write process. The adaptor of the invention enables the small form factor card to be used with any conventional smart card reader/writer.

While particular embodiments of the invention have been illustrated and described in detail herein, it should be understood that various changes and modifications may be made in the invention without departing from the spirit and intent of the invention as defined by the appended claims.

1. A small form factor contact smart card carrying an embedded chip with contacts for cooperation with contacts in a smart card reader/writer, comprising:
a card body having opposite side edges and a first end with means for attachment to a keychain or other tether, and a second end carrying the embedded chip; and
locking means on the card body for cooperation with locking means associated with a card reader/writer for holding the card in place in the reader/writer during an operation.

2. A small form factor smart card as claimed in claim 1, wherein:
the locking means comprises a detent in at least one of the opposite side edges of the card body.

3. A small form factor smart card as claimed in claim 2, wherein:
the locking means comprises a detent in each of the opposite side edges of the card body.

4. A small form factor smart card as claimed in claim 3, wherein:
the detent in one of the opposite side edges is spaced closer to the first end of the card body, and the detent in the other of the opposite side edges is spaced closer to the second end.

5. A small form factor smart card as claimed in claim 4, wherein:
said means for attachment of a keychain or other tether comprises an opening formed through said first end, said opening being reinforced.

6. A small form factor smart card as claimed in claim 5, wherein:
said card has a length of about 2.375 inches and a width of about 1 inch.

7. A small form factor contact smart card as claimed in claim 6, wherein:
the chip conforms to ISO 7816-xx.

8. An adaptor for adapting a small form factor contact smart card for use with a contact smart card reader/writer, or other reader/writer for smart cards, comprising:
a bifurcated main body portion adapted to be inserted into a port in the card reader/writer, said bifurcated main body portion having an elongate slot extending along its length, said slot in the main body portion adapted to receive a small form factor card and hold the card in properly aligned position in the card reader/writer so that the card can be read by the reader/writer; and
pull-tab means on the adaptor to enable the adaptor to be grasped for insertion of the adaptor into the port of the reader/writer and removal of the adaptor therefrom.

9. An adaptor as claimed in claim 8, wherein:
the bifurcated main body portion comprises a pair of parallel, spaced apart arms having inner confronting side edges defining said elongate slot.

10. An adaptor as claimed in claim 9, wherein:
locking means is on at least one of said inner confronting side edges for cooperation with complemental locking means on a card inserted into said elongate slot.

11. An adaptor as claimed in claim 10, wherein:
locking means is on each of said inner confronting side edges.

12. An adaptor as claimed in claim 11, wherein:
said locking means each comprise a spring arm.

13. In combination, a small form factor smart card and an adaptor for enabling the small form factor smart card to be read by contact smart card reader/writers, wherein:
said small form factor smart card comprises a card body having opposite side edges and a first end with means for attachment to a keychain or other tether, and a second end carrying an embedded chip; and
said adaptor comprises a bifurcated main body portion adapted to be inserted into a slot in a card reader/writer, said bifurcated main body portion having an elongate slot extending along its length for receiving the small form factor card and holding the card in properly aligned position in the card reader/writer so that the card can be read by the reader/writer.

14. The combination of claim 13, wherein:
locking means is on the card body for cooperation with complemental locking means on the adaptor.

15. The combination of claim 14, wherein:
pull-tab means is on the adaptor to enable the adaptor to be grasped for insertion of the adaptor into the slot of the reader/writer and removal of the adaptor therefrom.

16. The combination of claim 15, wherein:
the locking means on the card body comprises detents on the opposite side edges of the card body; and
the complemental locking means on the adaptor comprises spring arms on the adaptor at opposite sides of the elongate slot.
